(19) United States
(12) Patent Application Publication
(10) Pub. No.: US 2009/0185487 A1
(43) Pub. Date: Jul. 23, 2009

(54) AUTOMATED ADVANCE LINK ACTIVATION

(75) Inventors: Etai Adar, Yokneam Ilit (IL); Michael Bar-Joshua, Haifa (IL); Ilya Granovsky, Haifa (IL); Shaul Yifrach, Haifa (IL)

Correspondence Address: FREDERICK W. GIBB, III;Gibb Intellectual Property Law Firm, LLC, 2568-A RIVA ROAD, SUITE 304, ANNAPOLIS, MD, 21401, US

(73) Assignee: INTERNATIONAL BUSINESS MACHINES CORPORATION, ARMONK, NY (US)

(21) Appl. No.: 12/017,432

(22) Filed: Jan. 22, 2008

(51) Int. Cl. H04L 1/00

(52) U.S. Cl. 370/236

(57) ABSTRACT

Embodiments herein provide a transaction level mechanism that ensures that the links are operational right in time for the data flow, so that the data flow will not be impacted by delays associated with link recovery into the operational state. The path has links that have the ability to be in an inactive mode or an active mode. The embodiments herein transmit an “activation transmission” over the path to turn on the links within the path, before sending a data transfer (comprising packetized data) to turn on (wake up) the inactive links within the path, so that the actual data transfer does not experience any such start-up or wake-up delays.

### BACKGROUND

1. Field of the Invention

The embodiments of the invention generally relate to transmitting packetized data over a path that has links, where the links comprise the ability to be in an inactive mode and be in an active mode.

2. Description of Related Art

Various protocols are used to transmit packetized data over modem switch-based networks having links. One such protocol, PCI Express (PCIe®) is an increasingly popular I/O protocol based on packetized data transfer over high speed full duplex serial interconnects. PCIe® logos and trademarks are licensed by PCI-SIG members (3855 SW 153rd Drive, Beaverton, Oreg. 97006, USA). The analog transceivers responsible for the serial communication are major components of a PCIe® port. With technology advances allowing PCIe® speed increases and many PCIe® links being integrated on a single chip, PCIe® analog components (also referred to as HSS—High Speed Serializer/Deserializer) are becoming significant contributors to overall increases in power consumption. Therefore, advance techniques for PCIe® links power management are becoming increasingly important for keeping PCIe® links power low when the link is not fully utilized.

The PCIe® standard defines Active State Power Management (ASPM) of PCIe® links that allows autonomous link power management without operating system involvement. For example, two ASPM power states can be used: L0s and L1. While the 1 ASPM state allows significant power savings by shutting down large portions of the HSS and other logic partitions, recovery time from L1 into the operational state is significant and therefore a device-host transaction level handshake is required. The L0s low power state provides more modest power savings by separately powering down the receiver and transmitter. Due to the separate transmit and receive nature of L0s, the respective HSS part is powered down autonomously whenever transmit or receive links are not in use for certain amount of time.

### SUMMARY

The embodiments herein provide a transaction level mechanism that ensures that the links are operational in time for the data flow, so that the data flow will not be impacted by delays associated with link recovery into the operational state. The path has links that have the ability to be in an inactive mode or an active mode. The embodiments herein transmit an “activation transmission” over the path to turn on the links within the path, before sending a data transfer (comprising packetized data) to turn on (wake up) the inactive links within the path, so that the actual data transfer does not experience any such start-up or wake-up delays.

Thus, in all embodiments herein, this activation transmission places the links into the active mode. However, the activation transmission is not an actual data transmission, but instead is only used to turn on the links in the path. Thus, the activation transmission is devoid of the packetized data (and only comprises a transaction layer pocket) and is discarded by the ultimate receiver after being transmitted over the path to the receiver. Then, within a predetermined time after transmitting the activation transmission, the actual data transfer is transmitted over the path.

Thus, the links turn off from the active mode into the inactive mode after an activity time period (during which no transmissions are transmitted through the links) has expired. Similarly, the links turn on from the inactive mode into the active mode when a transmission is sent through the link. One disadvantage of such power-saving links is that a time delay occurs when the links turn on, and this delays transmissions being transmitted through the links over the data path. Therefore, the “predetermined time” (in which the data transmission is sent) mentioned above comprises a time period that is less than the activity time period, to ensure that the links will still be active when the data transfer is sent. Therefore, because the data transfer has been sent before the activity time period has expired, the links are active when the method transmits the data transfer. Some embodiment herein can further check whether an activity time associated with a previous data transmission period has expired, to see whether another activation transmission actually necessary when a data transmission is being prepared to be sent.

These and other aspects of the embodiments of the invention will be better appreciated and understood when considered in conjunction with the following description and the accompanying drawings. It should be understood, however, that the following descriptions, while indicating embodiments of the invention and numerous specific details thereof, are given by way of illustration and not of limitation. Many changes and modifications may be made within the scope of the embodiments of the invention without departing from the spirit thereof, and the embodiments of the invention include all such modifications.

### BRIEF DESCRIPTION OF THE DRAWINGS

The embodiments of the invention will be better understood from the following detailed description with reference to the drawings, in which:

FIG. 1 is a schematic diagram of link connected to devices; and

FIG. 2 is a flow diagram illustrating a method embodiment of the invention.

### DETAILED DESCRIPTION OF EMBODIMENTS

The embodiments of the invention and the various features and advantageous details thereof are explained more fully with reference to the non-limiting embodiments that are illustrated in the accompanying drawings and detailed in the following description. It should be noted that the features illustrated in the drawings are not necessarily drawn to scale. Descriptions of well-known components and processing techniques are omitted so as to not unnecessarily obscure the embodiments of the invention. The examples used herein are intended merely to facilitate an understanding of ways in which the embodiments of the invention may be practiced and to further enable those of skill in the art to practice the embodiments of the invention. Accordingly, the examples should not be construed as limiting the scope of the embodiments of the invention.

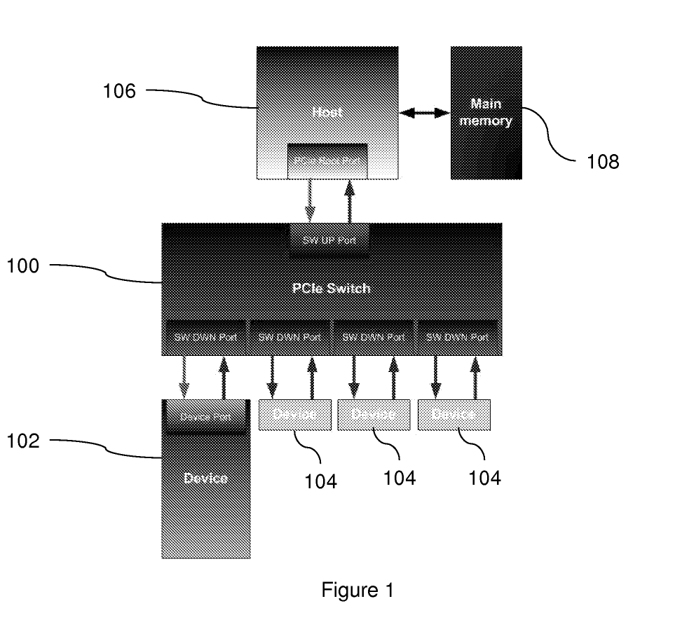

As mentioned above, the PCIe® standard defines Active State Power Management (ASPM) of PCIe® links that allows autonomous link power management without operating system involvement. FIG. 1 illustrates a PCIe® switch 100 that is connected to various devices 102, 104 and to a host 106, having access to a memory 108, for example.

Recovery time from L1 into an operational state is significant and therefore a transaction level handshake (device-host (102-106)) is required. However, in many cases intensive use of L0s leads to degradation in effective bandwidth, since the application is not aware of autonomous link power management and doesn't account for additional delays associated with recovery from L0s state. As a result, many applications waste power by intentionally disabling L0s, as the performance degradation they experience outweighs potential power savings. Furthermore, this problem increases with the latest manufacturing technologies that require more time to reacquire symbol lock-up when transitioning from the L0 state to an active state.

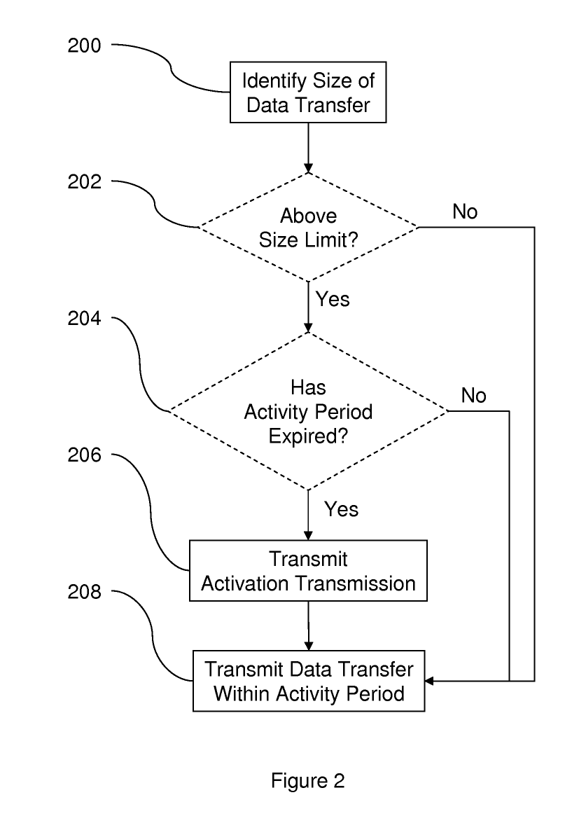

FIG. 2 illustrates in flowchart form how the embodiments herein address these issues and provide a transaction level mechanism that ensures that the links are operational right on time for the data flow, so that the data flow will not be impacted by delays associated with link recovery into the operational state. As mentioned above, the path has links that have the ability to be in an inactive mode or an active mode. The embodiments herein transmit an “activation transmission” over the path to turn on the links within the path (item 206), before sending a data transfer 208 (comprising packetized data) to turn on (wake up) the inactive links within the path, so that the actual data transfer does not experience any such start-up or wake-up delays. The activation transmission is sent while the data transfer is being prepared, and thus the activation transmission does not delay the send of the data transfer.

Thus, in all embodiments herein, this activation transmission 206 places the links into the active mode. This activation transmission is achieved by issuing a special transaction layer packet that travels along the path of subsequent large data block transmission and wakes up the links. However, the activation transmission 206 is not an actual data transmission, but instead is only used to turn on the links in the path. Thus, the activation transmission 206 is devoid of the packetized data and is discarded by the ultimate receiver (host 106) after being transmitted over the link (100) to the receiver. Then, within a predetermined time after transmitting the activation transmission 206, the actual data transfer 208 is transmitted over the path.

The links turn off from the active mode into the inactive mode after an activity time period (during which no transmissions are transmitted through the links) has expired, to conserve power. Similarly, the links turn on from the inactive mode into the active mode when a transmission is sent through the link. As discussed above, one disadvantage of such power-saving links is that a time delay occurs when the links turn on, and this delays transmissions being transmitted through the links over the data path.

In order to address these issues, the “predetermined time” (in which the data transmission is sent) mentioned above comprises a time period that is less than the activity time period to ensure that the links will still be active when the data transfer is sent. Therefore, because the data transfer is sent before the activity time period has expired, the links are active when the method transmits the data transfer.

Some optional embodiments herein can selectively send the activation transmission only with large data transmissions or only with small data transmissions. With respect to large data transmissions, the start-up or wake-up delay of the links may be overcome by the speed with which smaller data transmissions travel across the path. Also, advanced link activation makes sense for smaller data payloads, since in these cases latency impact is more significant. For a large data transfer, the initial latency penalty may be offset by the large amount of data transferred. However, small sparse data transmissions would be mostly impacted by the increased latencies. Examples include high priority traffic (interrupts, messages, etc.) or real time traffic with reserved bandwidth (audio/video). These types of traffic may encounter unplanned link activation delays that would impact overall performance.

Such optional embodiments first identify the size of the data transfer that is to be transmitted over the path in item 200. Then, if the size of the data transfer is above a predetermined limit (item 202), which could be a minimum or a maximum, the method transmits the “activation transmission” over the path. Otherwise, the process simply transmits the data transfer, without sending the activation transmission. Other embodiments can skip steps 200 and 202 and always transmit the activation transmission, irrespective of the size of the data transfer.

As shown in item 204, some optional embodiments herein can further check whether the activity time period has expired since the last time a previous data transfer was sent, to see whether another activation transmission is actually necessary when a data transmission is being prepared to be sent. Therefore, if the activity period has expired since the most recent data transmission, processing proceeds to item 206 and the activation transmission is sent. Otherwise, since the links are still active (the activity period has not expired) the next data transfer can be sent, without sending the activation transmission.

Thus, links will be kept active only if there is some sort of activity and data transfer is expected to happen soon, otherwise there is not much sense in keeping the link awake. Furthermore, the embodiments herein can work with different application specific triggers that are closely related to the operational of particular devices. For instance, a device that is planning a large data movement in the upstream direction (for example, based on a DMA engine work state) could issue the link activation message so that the links would be operational right in time for the DMA data movement.

Therefore, triggers for the link activation packet can include a situation where the activity period has expired AND the current application state requires links to remain active (to allow high priority/unplanned traffic with low latencies). Further, a trigger for the link activation packet can include when a data transfer (not necessarily large) will commence within the activity period.

The above mechanism ensures that links are all in the active power state when the large data transfer occurs. This is achieved by advance issuing of a special transaction layer packet that travels along the path of subsequent large data block transmission and wakes up the links 100.

For example, in one PCIe® storage adapter workflow, an adapter may be attached to a PCIe® switch and the PCIe® hierarchy may include a number of switches, so that several PCIe® link hops would be required to reach the host. Therefore, one ordinarily skilled in the art would understand that the schematic diagram in FIG. 1 can be considered to illustrate multiple such switches and link hops. An adapter fetches a transfer descriptor from the host and initiates data retrieval. Meanwhile, the links between the adapter and the host switch into L0s power state due to lack of active traffic. With the embodiments herein, the adapter issues an upstream Vendor Defined Message (VDM) of Type 1 before enough data is accumulated to initiate a PCIe® transfer to the host. Such message is forwarded in all the intermediate switches to the upstream facing port and by that are routed to the host. The host silently discards the received message (per PCIe® definition of Vendor defined Messages of Type 1) thus there are no side effects of activation transmission message reception by the host.

The data block transfer follows the VDM packet whenever data is ready in the adapter. Because all the links on the way to the host will have already switched to the active state, data transfer does not encounter additional delays associated with link recovery from L0s state into L0 state. Similar mechanism can be applied for improving downbound transaction delays associated with L0s recovery. The host 106 could use Vendor Defined Messages of Type 1 with ID-based routing to wake up a route to certain device prior to issuing operations towards that device 102. Alternatively, the host 106 may issue VDM Type 1 packet with a broadcast routing, waking up the entire hierarchy.

The method disclosed herein can also be used to improve power savings associated with L0s. Currently devices may apply conservative decision techniques upon entering L0s, due to significant penalty of L0s recovery. Because the embodiments herein reduce or even eliminates L0s recovery penalties, and L0s entry may be initiated earlier for improved power savings.

The embodiments of the invention can take the form of a computer program product accessible from a computer-usable or computer-readable medium providing program code for use by or in connection with a computer or any instruction execution system. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

The foregoing description of the specific embodiments will so fully reveal the general nature of the invention that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments of the invention have been described in terms of embodiments, those skilled in the art will recognize that the embodiments of the invention can be practiced with modification within the spirit and scope of the appended claims.

What is claimed is:

1. A method of transmitting packetized data over a path having at least one link, wherein said at least one link comprises an ability to be in an inactive mode and be in an active mode, said method comprising:
transmitting an activation transmission over said path, wherein said activation transmission places said at least one link into said active mode, and wherein said activation transmission is devoid of said packetized data and is discarded after being transmitted over said path; and
within a predetermined time after said transmitting of said activation transmission, transmitting a data transfer comprising said packetized data over said path.

2. The method according to claim 1, wherein said at least one link turns off from said active mode into said inactive mode after an activity time period, during which no transmissions are transmitted through said at least one link, has expired,
wherein said at least one link turns on from said inactive mode into said active mode when a transmission is sent through said link, and
wherein a time delay occurs when said at least one link turns on, and said time delay delays transmissions being transmitted through said at least one link.

3. The method according to claim 2, wherein said predetermined time comprises a time period less than said activity time period, such that said at least one link is active when said transmitting of said data transfer is performed.

4. A method of transmitting packetized data over a path having at least one link, wherein said at least one link comprises an ability to be in an inactive mode and be in an active mode, said method comprising:
identifying a size of a data transfer comprising said packetized data that is to be transmitted over said path; and
if said size of said data transfer is above a predetermined limit, transmitting an activation transmission over said path, wherein said activation transmission places said at least one link into said active mode, and wherein said activation transmission is devoid of said packetized data and is discarded after being transmitted over said path; and
within a predetermined time after said transmitting of said activation transmission, transmitting said data transfer over said path.

5. The method according to claim 4, wherein said at least one link turns off from said active mode into said inactive mode after an activity time period, during which no transmissions are transmitted through said at least one link, has expired,
wherein said at least one link turns on from said inactive mode into said active mode when a transmission is sent through said link, and
wherein a time delay occurs when said at least one link turns on, and said time delay delays transmissions being transmitted through said at least one link.

6. The method according to claim 5, wherein said predetermined time comprises a time period less than said activity time period, such that said at least one link is active when said transmitting of said data transfer is performed.
